(19) United States
(12) Patent Application Publication
(10) Pub. No.: US 2018/0210575 A1
(43) Pub. Date: Jul. 26, 2018

(54) TOUCH SCREEN, METHOD FOR MANUFACTURING TOUCH SCREEN, AND TOUCH DISPLAY DEVICE

(71) Applicants: BOE TECHNOLOGY GROUP CO., LTD., Beijing (CN); HEFEI XINSHENG OPTOELECTRONICS TECHNOLOGY CO., LTD, Anhui (CN)

(72) Inventors: Xiaodong XIE, Beijing (CN); Ming HU, Beijing (CN); Ming ZHANG, Beijing (CN); Jing WANG, Beijing (CN); Yu ZHU, Beijing (CN); Jian TIAN, Beijing (CN)

(21) Appl. No.: 15/720,011

(22) Filed: Sep. 29, 2017

(30) Foreign Application Priority Data
Jan. 20, 2017 (CN) 201710049457.5

(51) Int. Cl. G06F 3/044

(52) U.S. Cl. CPC G06F 3/044

(57) ABSTRACT

A touch screen includes a first substrate; a touch sensing structure including a first touch layer and a second touch layer; a first flexible circuit board and a second flexible circuit board, wherein the first touch layer and the second touch layer are respectively provided on both sides of the first substrate, the first touch layer includes at least one first electrode lead wire, and the second touch layer comprises at least one second electrode lead wire, the first flexible circuit board and the second flexible circuit board are respectively pressed on both sides of the first substrate, the first electrode lead wire is electrically connected with the first flexible circuit board, and the second electrode lead wire is electrically connected with the second flexible circuit board.

### CROSS-REFERENCE TO RELATED APPLICATIONS

The present application claims priority to Chinese Patent Application No. 201710049457.5, filed Jan. 20, 2017, and entitled “touch screen, method for manufacturing touch screen, and touch display device”, the entire contents of which are incorporated herein by reference.

### TECHNICAL FIELD

The present disclosure relates to a touch screen, a method for manufacturing a touch screen, and a touch display device.

### BACKGROUND

With the continuous development of touch technology, applications of touch technology in mobile phones, tablets, notebook computers and other electronic products are increasingly widespread. Usually, the touch screen can be divided into capacitive touch screen, electromagnetic touch screen, resistive touch screen and optical touch screen and other types. Due to low cost, wear resistance, long life and other advantages of the capacitive touch screen, the development of which is particularly rapid. The capacitive touch screen can be divided into an out-cell touch screen and an embedded touch screen. The out-cell touch screen includes GG (Glass-Glass) type, GFF (Glass-Film-Film) type and OGS (One Glass Solution) type, etc. The embedded touch screen includes surface (On-cell) type, embedded (In-cell) type, and so on.

With the development of electronic products, the demand for the performance of electronic products is getting higher and higher. The electronic products require both excellent electrical performance, such as touch sensitivity and accuracy, and beautiful appearance, such as ultra-narrow frame, no frame, etc. For the electronic products, the frame is getting narrower, the frame of the touch screen is also required to become narrower, that is, the edge of wiring region of the touch screen is also required to become narrower, or even no frame. Thus electronic products with a limited size can show content as much as possible, the user experience can be enhanced, and the market competitiveness of electronic products can be improved. Currently, the wiring of the touch screen is on the edge, when the minimum line width reaches the limit of the process, the frame of the touch screen can not be narrowed continually.

### SUMMARY

At least one embodiment of the present disclosure provides a touch screen, a method for manufacturing a touch screen, and a touch display device having the touch screen.

At least one embodiment of the present disclosure provides a touch screen including a first substrate; a touch sensing structure including a first touch layer and a second touch layer; a first flexible circuit board and a second flexible circuit board, wherein the first touch layer and the second touch layer are respectively provided on both sides of the first substrate, the first touch layer includes at least one first electrode lead wire, and the second touch layer includes at least one second electrode lead wire, the first flexible circuit board and the second flexible circuit board are respectively pressed on both sides of the first substrate, the first electrode lead wire is electrically connected with the first flexible circuit board, and the second electrode lead wire is electrically connected with the second flexible circuit board.

According to the touch screen provided by at least one embodiment of the present disclosure, by pressing the first flexible circuit board and the second flexible circuit board respectively against both sides of the first substrate, the wirings on the edge can be reduced or eliminated, the area of the frame occupied by the electrode lead wires can be significantly reduced to achieve a ultra-narrow frame, and the appearance performance of electronic products can be increased. According to the touch screen provided by at least one embodiment of the present disclosure, by disposing the first touch layer and the second touch layer on both sides of the first substrate, signal interferences between the first touch layer and the second touch layer can be reduced, so that parasitic capacitances between the first electrode lead wire and the second electrode lead wire can be reduced or eliminated, which effectively improves the sensitivity and accuracy of the touch. According to the touch screen provided by at least one embodiment of the present disclosure, the first touch layer is insulated from the second touch layer by the first substrate so that it is not necessary to separately provide an interlayer insulating layer or to make an interlayer insulating pattern to bridge the touch electrodes. Thus, the manufacturing process can be simplified and the product yield can be improved.

For example, in the touch screen provided by one embodiment of the present disclosure, both sides of the first substrate are respectively a first surface and a second surface, the first touch layer is disposed on the first surface, and the second touch layer is disposed on the second surface.

For example, in the touch screen provided by one embodiment of the present disclosure, a first wiring region is disposed on the first surface, a second wiring region is disposed on the second surface, the first wiring region extends in a first direction on the first surface, the second wiring region extends in a second direction on the second surface, the first flexible circuit board is pressed on the first wiring region, the second flexible circuit board is pressed on the second wiring region, and the first direction is perpendicular to the second direction.

For example, in the touch screen provided by one embodiment of the present disclosure, a first wiring region is disposed on the first surface, a second wiring region is disposed on the second surface, the first wiring region extends in a second direction on the first surface, the second wiring region extends in a second direction on the second surface, the first flexible circuit board is pressed on the first wiring region, the second flexible circuit board is pressed on the second wiring region, and the first wiring region and the second wiring region are at least partially overlapped in a direction perpendicular to the first substrate.

For example, the touch screen provided by one embodiment of the present disclosure further includes a cover substrate, wherein the cover substrate is attached to the first substrate by an optical glue, a surface of the cover substrate facing the first substrate is a third surface, the second touch layer is disposed on the third surface, a surface of the first substrate away from the cover substrate is a first surface, and the first touch layer is disposed on the first surface.

For example, in the touch screen provided by one embodiment of the present disclosure, the first substrate includes a first wiring region, the cover substrate includes a third wiring region, the first wiring region extends in a first direction on the first surface, the third wiring region extends in a second direction on the third surface, the first flexible circuit board is pressed on the first wiring region, the second flexible circuit board is pressed on the third wiring region, and the first direction is perpendicular to the second direction.

For example, in the touch screen provided by one embodiment of the present disclosure, the first substrate includes a first wiring region, the cover substrate includes a third wiring region, the first wiring region extends in a second direction on the first surface, the third wiring region extends in a second direction on the third surface, the first flexible circuit board is pressed on the first wiring region, the second flexible circuit board is pressed on the third wiring region, and the first wiring region and the third wiring region are at least partially overlapped in a direction perpendicular to the first substrate.

At least one embodiment of the present disclosure provides a method for manufacturing a touch screen, including: providing a first substrate; forming a touch sensing structure; providing a first flexible circuit board and a second flexible circuit board, wherein the touch sensing structure includes a first touch layer and a second touch layer, the first touch layer and the second touch layer are respectively provided on both sides of the first substrate, the first touch layer includes at least one first electrode lead wire, and the second touch layer includes at least one second electrode lead wire, the first flexible circuit board and the second flexible circuit board are respectively pressed on both sides of the first substrate, the first electrode lead wire is electrically connected with the first flexible circuit board, and the second electrode lead wire is electrically connected with the second flexible circuit board.

For example, in the method for manufacturing a touch screen provided by one embodiment of the present disclosure, both sides of the first substrate are respectively a first surface and a second surface, the first touch layer is disposed on the first surface, and the second touch layer is disposed on the second surface.

For example, the method for manufacturing a touch screen provided by one embodiment of the present disclosure includes forming a first wiring region and a second wiring region on both sides of the first substrate, wherein the first wiring region extends in a first direction on the first surface, the second wiring region extends in a second direction on the second surface, the first flexible circuit board is pressed on the first wiring region, the second flexible circuit board is pressed on the second wiring region, and the first direction is perpendicular to the second direction.

For example, the method for manufacturing a touch screen provided by one embodiment of the present disclosure includes forming a first wiring region and a second wiring region on both sides of the first substrate, wherein the first wiring region extends in a second direction on the first surface, the second wiring region extends in a second direction on the second surface, the first flexible circuit board is pressed on the first wiring region, the second flexible circuit board is pressed on the second wiring region, and the first wiring region and the second wiring region are at least partially overlapped in a direction perpendicular to the first substrate.

For example, the method for manufacturing a touch screen provided by one embodiment of the present disclosure further includes: providing a cover substrate, wherein the cover substrate is attached to the first substrate by an optical glue, a surface of the cover substrate facing the first substrate is a third surface, the second touch layer is disposed on the third surface, a surface of the first substrate away from the cover substrate is a first surface, and the first touch layer is disposed on the first surface.

For example, the method for manufacturing a touch screen provided by one embodiment of the present disclosure further includes: forming a first wiring region on the first substrate, forming a third wiring region on the cover substrate, wherein the first wiring region extends in a first direction on the first surface, the third wiring region extends in a second direction on the third surface, the first flexible circuit board is pressed on the first wiring region, the second flexible circuit board is pressed on the third wiring region, and the first direction is perpendicular to the second direction.

For example, the method for manufacturing a touch screen provided by one embodiment of the present disclosure further includes: forming a first wiring region on the first substrate, forming a third wiring region on the cover substrate, wherein the first wiring region extends in a second direction on the first surface, the third wiring region extends in a second direction on the third surface, the first flexible circuit board is pressed on the first wiring region, the second flexible circuit board is pressed on the third wiring region, and the first wiring region and the third wiring region are at least partially overlapped in a direction perpendicular to the first substrate.

At least one embodiment of the present disclosure provides a touch display device including any one of the above described touch screens.

### BRIEF DESCRIPTION OF THE DRAWINGS

In order to clarify technical solutions in embodiments of the present disclosure more clearly, drawings of the embodiments are briefly described hereinafter. It will be apparent that the drawings in the following description are merely some embodiments of the present disclosure, and are not intended to limit the present disclosure.

FIG. 1a is a schematic plan diagram of wiring on the edge of a touch screen;

FIG. 1b is a partial cross-sectional view along the direction of line A-A′ in the FIG. 1a;

FIG. 2a is a structural schematic diagram of a first surface of a touch screen provided by an embodiment of the present disclosure;

FIG. 2b is a structural schematic diagram of a second surface of a touch screen provided by an embodiment of the present disclosure;

FIG. 2c is another structural schematic diagram of a first surface of a touch screen provided by an embodiment of the present disclosure;

FIG. 3a is a structural schematic diagram of a first surface of a touch screen provided by another embodiment of the present disclosure;

FIG. 3b is a structural schematic diagram of a second surface of a touch screen provided by another embodiment of the present disclosure;

FIG. 3c is a partial cross-sectional view along the direction of line B-B′ in the FIG. 3a;

FIG. 4a is a structural schematic diagram of a first surface of a touch screen provided by another embodiment of the present disclosure;

FIG. 4b is a structural schematic diagram of a third surface of a touch screen provided by another embodiment of the present disclosure;

FIG. 5a is a structural schematic diagram of a first surface of a touch screen provided by another embodiment of the present disclosure;

FIG. 5b is a structural schematic diagram of a third surface of a touch screen provided by another embodiment of the present disclosure;

FIG. 5c is a partial cross-sectional view along the direction of line C-C′ in the FIG. 5a; and

FIGS. 6a-6c are exemplary structural schematic diagrams of different touch electrodes provided by embodiments of the present disclosure.

### DETAILED DESCRIPTION

In order to make the objectives, technical solutions and advantages of the embodiments of the present disclosure clearer, hereinafter, the technical solutions of the embodiments of the present disclosure will be further described in detail with reference to the accompanying drawings. It is obvious that the described embodiments are part of the present disclosure, and not all embodiments. Based on the described embodiments of the present disclosure, all other embodiments obtained by those skilled in the art without paying creative effort are within the scope of the present disclosure.

Unless otherwise defined, technical terms or scientific terms used in this disclosure should be of ordinary sense to those skilled in the art to which this disclosure pertains. The “first”, “second” and similar words used in this disclosure do not denote any order, quantity or importance, but are merely used to distinguish between different constituents. The words “comprising” or “including” and the like mean that the elements or objects preceding the word cover the elements or objects listed later in the word and their equivalents, without excluding other elements or objects. The words “connecting” or “connection” and the like are not limited to physical or mechanical connections, but may include electrical connections, whether direct or indirect. The words “upper”, “lower”, “left”, “right” and the like are used only to represent the relative positional relationship, and the relative positional relationship may be changed accordingly when the absolute position of the object to be described changes.

The various parts or structures in the drawings are not strictly drawn to scale, and the dimensions of various parts or structures, such as the thickness of the added layers, the width of the electrodes, etc., may be exaggerated or reduced for clarity, but these should not be used to limit the scope of the present disclosure.

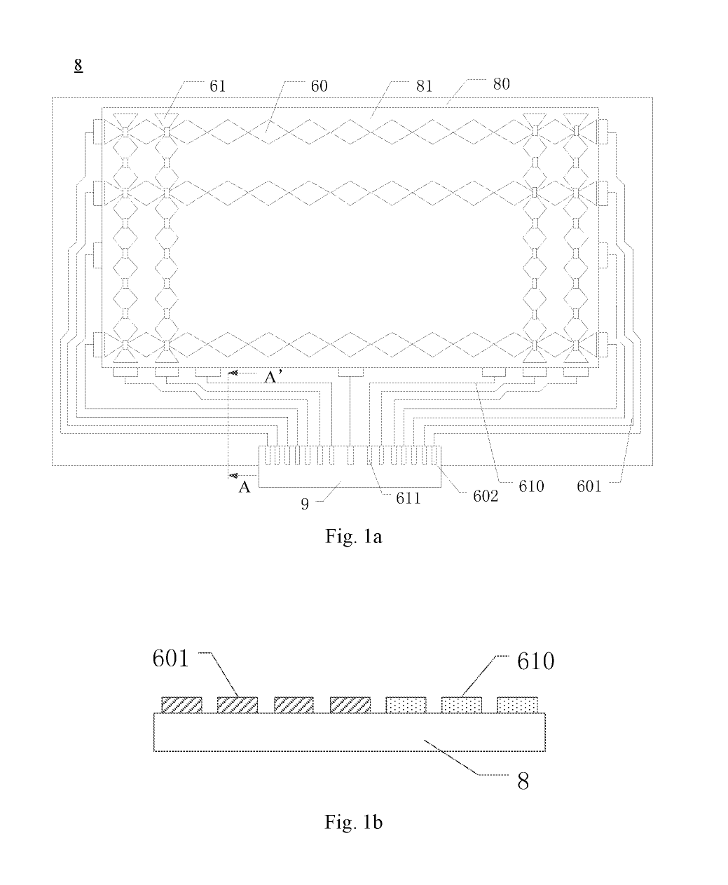

FIG. 1a is a schematic plan diagram of wiring on the edge of a touch screen. FIG. 1b is a partial cross-sectional view along the direction of line A-A′ in the FIG. 1a.

As shown in FIGS. 1a and 1b, the touch screen 8 includes a touch region 81 and a frame region 80, a touch sensing electrode 60 and a touch driving electrode 61 which are insulated from each other and are interposed in the touch region 81. In the frame region 80, the touch sensing electrode 60 is led out by the touch sensing electrode lead wire 601 and connected to the electrode pin 602 on the side of the frame region 80. In the frame region 80, the touch driving electrode 61 is led out by the touch driving electrode lead wire 610 and connected to the electrode pin 611 on the side of the frame region 80. These lead wires are finally connected to the driving circuit (or driving chip, not shown) via the flexible circuit board 9 so that the driving circuit can transmit a control signal to the touch screen 8 or receive an inductive signal from the touch screen 8 and enable touch detection through the touch screen 8. As shown in FIG. 1b, the touch sensing electrode lead wire 601 and the touch driving electrode lead wire 610 are located on the same plane and are wired on the edge. In order to ensure that the touch screen 8 can operate normally, the touch sensing electrode lead wire 601 and the touch drive electrode lead wire 610 must be disposed staggerly from each other and cannot intersect nor overlap, to avoid that touch detection cannot be performed due to that signal interferences between the touch sensing electrode 60 and the touch driving electrode 61. These lead wires will occupy most of the area of the frame region 80, resulting in a wider width of the frame region 80, which is difficult to meet the need for narrowing the frame of the touch screen 8. In order to reduce the area of the frame region 80, it is necessary to minimize the width of the electrode lead wire, but when the width of the electrode lead wire reaches the limit of the process, the frame of the touch screen cannot be narrowed continually.

An embodiment of the present disclosure provides a touch screen, a method for manufacturing a touch screen, and a touch display device having the touch screen.

An embodiment of the present disclosure provides a touch screen including a first substrate; a touch sensing structure including a first touch layer and a second touch layer; a first flexible circuit board and a second flexible circuit board. The first touch layer and the second touch layer are respectively provided on both sides of the first substrate. The first touch layer includes at least one first electrode lead wire, and the second touch layer includes at least one second electrode lead wire. The first flexible circuit board and the second flexible circuit board are respectively pressed against both sides of the first substrate. The first electrode lead wire is electrically connected with the first flexible circuit board. The second electrode lead wire is electrically connected with the second flexible circuit board.

According to the touch screen of the present embodiment, by pressing the first flexible circuit board and the second flexible circuit board respectively against both sides of the first substrate, the wirings on the edge can be reduced or eliminated, the area of the frame occupied by the electrode lead wires can be significantly reduced to achieve a ultra-narrow frame, and the appearance performance of electronic products can be increased greatly. In addition, by disposing the first touch layer and the second touch layer on both sides of the first substrate, signal interferences between the first touch layer and the second touch layer can be reduced, so that parasitic capacitances between the first electrode lead wire and the second electrode lead wire can be reduced or eliminated, which effectively improves the sensitivity and accuracy of the touch. In addition, for the touch panel, the first touch layer is insulated from the second touch layer by the first substrate so that it is not necessary to separately provide an interlayer insulating layer or to make an interlayer insulating pattern to bridge the touch electrodes. Thus, the manufacturing process can be simplified and the product yield can be improved.

The touch screen, the method for manufacturing a touch screen, and the touch display device provided by embodiments of the present disclosure will be described in detail with reference to the accompanying drawings, but the present disclosure is not limited to these specific embodiments.

### The First Embodiment

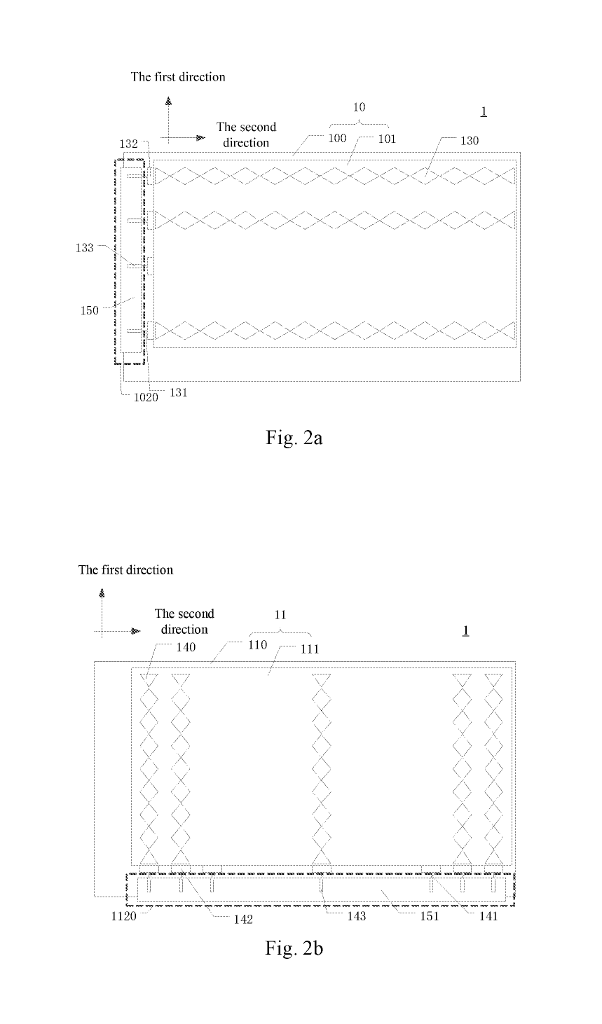

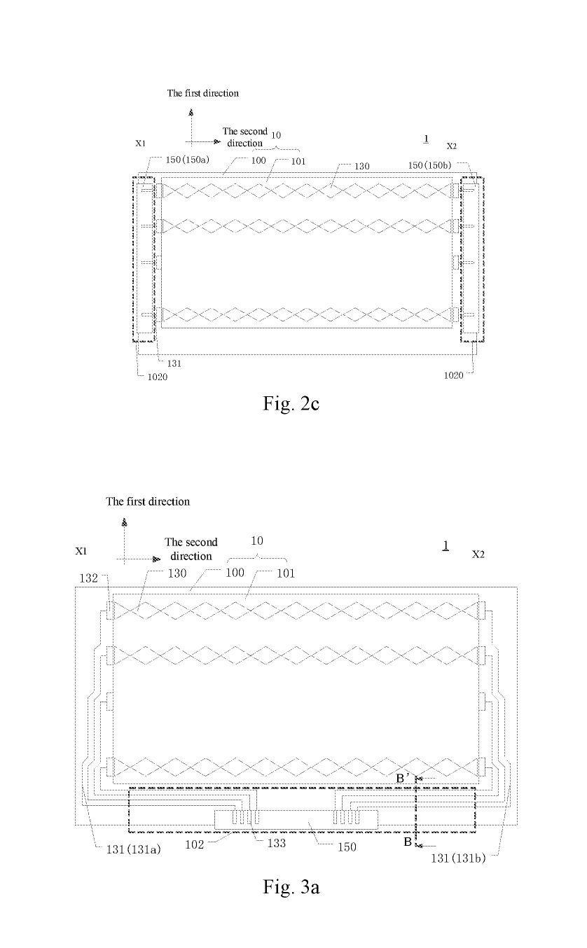

FIG. 2a is a structural schematic diagram of a first surface of a touch screen provided by an embodiment of the present disclosure. FIG. 2b is a structural schematic diagram of a second surface of a touch screen provided by an embodiment of the present disclosure. FIG. 2c is another structural schematic diagram of a first surface of a touch screen provided by an embodiment of the present disclosure. It should be noted that only a portion of the relevant structure is shown in FIGS. 2a to 2c for a clearer illustration.

For example, as shown FIGS. 2a and 2b, in a touch screen provided by the first embodiment includes a first substrate 1; a touch sensing structure comprising a first touch layer and a second touch layer; a first flexible circuit board 150 and a second flexible circuit board 151. The first touch layer and the second touch layer are respectively provided on both sides of the first substrate. The first touch layer includes at least one first touch electrode 130 and at least one first electrode lead wire 131, and the second touch layer includes at least one second touch electrode 140 and at least one second electrode lead wire 141. The first flexible circuit board 150 and the second flexible circuit board 151 are respectively pressed against both sides of the first substrate. The first electrode lead wire 131 is electrically connected with the first flexible circuit board 150, so as to be connected to the driving circuit (or driving chip). The second electrode lead wire 141 is electrically connected with the second flexible circuit board 151, so as to be connected to the driving circuit (or driving chip).

For example, both sides of the first substrate 1 may be a first surface 10 and a second surface 11, respectively. The first surface 10 includes a first touch region 101 and a first frame region 100, and the second surface 11 includes a second touch region 111 and a second frame region 110.

For example, the edge of the first touch region 101 may be provided with a first connection electrode 132, the edge of the second touch region 111 may be provided with a second connection electrode 142. The first touch electrode 130 is electrically connected to the first electrode lead wire 131 through the first connection electrode 132, and the second touch electrode 140 is electrically connected to the second electrode lead wire 141 through the second connection electrode 142.

For example, one of the first touch electrode 130 and the second touch electrode 140 is a touch sensing electrode and the other is a touch driving electrode.

For example, as shown in FIG. 2a, the first touch layer is disposed on the first surface 10, and the first touch electrode 130 is disposed within the first touch region 101 and extends in a second direction. The first frame region 100 includes a first wiring region 1020 extending in a first direction. A first electrode pin 133 and a first electrode lead wire 131 are provided within the first wiring region 1020. The first flexible circuit board 150, for example, may be pressed into the first wiring region 1020 by an anisotropic conductive adhesive and electrically connected to the first electrode lead wire 131 through the first electrode pin 133.

For example, as shown in FIG. 2b, the second touch layer is disposed on the second surface 11, and the second touch electrode 140 is disposed within the second touch region 111 and extends in a first direction. The second frame region 110 includes a second wiring region 1120 extending in a second direction. A second electrode pin 143 and a second electrode lead wire 141 are provided within the second wiring region 1120. The second flexible circuit board 151, for example, may be pressed into the second wiring region 1120 by an anisotropic conductive adhesive and electrically connected to the second electrode lead wire 141 through the second electrode pin 143.

The first flexible circuit board 150 and the second flexible circuit board 151 are electrically connected to an external driving circuit (or a driving chip, not shown) so that the driving circuit can transmit a control signal to the touch screen or receive an induction signal to achieve touch detection and touch control.

According to the touch screen provided by the present embodiment, by pressing the first flexible circuit board 150 on the first surface 10 and pressing the second flexible circuit board 151 on the second surface 11, the wirings on the edge can be reduced or eliminated, the area of the frame occupied by the electrode lead wires can be significantly reduced to achieve an ultra-narrow frame, and the appearance performance of electronic products can be increased greatly.

For example, the first substrate 1 may be a transparent substrate, and may be, for example, a glass substrate, a plastic substrate, a ceramic substrate or other suitable substrate, and may have a thickness of 0.2 mm to 0.7 mm. The first touch electrode 130 is insulated from the second touch electrode 140 by the first substrate 1, so that signal interferences between the first touch electrode 130 and the second touch electrode 140 can be reduced, and parasitic capacitances between the first electrode lead wire 131 and the second electrode lead wire 141 can be reduced or eliminated, which effectively improves the sensitivity and accuracy of the touch. In addition, with the arrangement and the structure of the present embodiment, it is possible to reduce the interlayer insulating layer between the first touch electrode 130 and the second touch electrode 140 provided separately on different layers, or the interlayer insulation pattern between the first touch electrode 130 and the second touch electrode 140 provided on the same layer, to achieve bridging between adjacent electrode segments. Thus, the manufacturing process can be simplified and the product yield can be improved. For example, the interlayer insulating layer or the interlayer insulating pattern may be prepared using an insulating material such as silicon oxide, silicon nitride, silicon oxynitride or the like.

For example, the first direction and the second direction are perpendicular to each other, and the first touch electrode 130 and the second touch electrode 140 may overlap each other in a direction perpendicular to the plane of the first substrate 1. For example, the first touch electrode 130 and the second touch electrode 140 may form a self-capacitive touch structure, and a touch position may be determined by detecting the change of the respective capacitance values of the first touch electrode 130 and the second touch electrode 140. Alternatively, the first touch electrode 130 and the second touch electrode 140 may form a mutual-capacitive touch structure, the first touch electrode 130 and the second touch electrode 140 may form a capacitance at the position of overlapping, and a touch position may be determined by detecting the change of the capacitance values at the position of overlapping.

For example, as shown in FIG. 2c, in the second direction, the first flexible circuit board 150 may include a first portion 150a on the X1 side and a second portion 150b on the X2 side. Two portions of first flexible circuit boards 150 (the first portion 150a and the second portion 150b) are more advantageous for the first touch electrode 130 to receive the drive signal. The first portion 150a and the second portion 150b are respectively pressed in the first wiring region 1020 on the X1 side and the X2 side, so that the wiring on the edge can be reduced or canceled, and the area occupied by the electrode lead wires of the frame region is reduced to achieve an ultra-narrow frame.

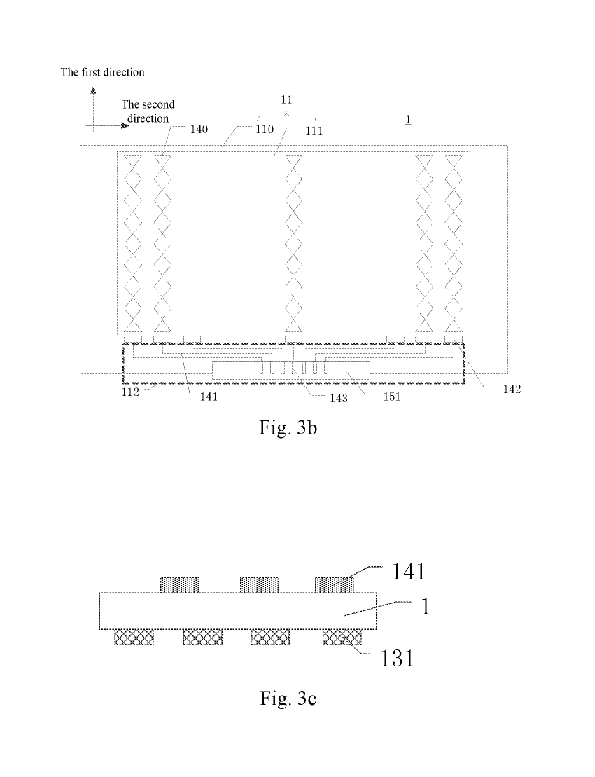

FIG. 3a is a structural schematic diagram of a first surface of another touch screen provided by the present embodiment. FIG. 3b is a structural schematic diagram of a second surface of another touch screen provided by the present embodiment. FIG. 3c is a partial cross-sectional view along the direction of line B-B′ in the FIG. 3a.

As shown in FIGS. 3a and 3b, in another touch screen provided by the present embodiment, a method of wiring on the edge is used to achieve the connection of the touch electrode and the flexible circuit board. The first frame region 100 includes a first wiring region 102 extending in a second direction. The second frame region 110 includes a second wiring region 112 extending in a second direction. The first electrode lead wire 131 is collected in the first wiring region 102, and the first electrode pin 133 is disposed in the first wiring region 102. For example, the first flexible circuit board 150 is pressed in the first wiring region 102 by an anisotropic conductive paste and is electrically connected to the first electrode lead wire 131 through the first electrode pin 133. The second electrode lead wire 141 is collected in the second wiring region 112, and the second electrode pin 143 is disposed in the second wiring region 112. For example, the second flexible circuit board 151 is pressed in the second wiring region 112 by anisotropic conductive paste and is electrically connected to the second electrode lead wire 141 through the second electrode pin 143. For example, the first wiring region 102 and the second wiring region 112 are at least partially overlapped in the direction perpendicular to the plane of the first substrate 1. As a result, the first flexible circuit board 150 and the second flexible circuit board 151 are at least partially overlapped in the direction perpendicular to the plane of the first substrate 1. As shown in FIG. 3c, the first electrode lead wire 131 and the second electrode lead wire 141 are also at least partially overlapped in the direction perpendicular to the plane of the first substrate 1, so that the number of the electrode lead lines of the first frame region 100 and the second frame region 110 can be reduced.

In another touch screen provided by the present embodiment, the leading paths of the touch electrode lead wire are provided on the surfaces on both sides of the first substrate 1. By stacking the upper layer and the lower layer, the first electrode lead wire 131 and the second electrode lead wire 141 can be intersected or overlapped in space, so that the area occupied by the electrode lead wires of the frame region can be significantly reduced and the parasitic capacitance generated between the first electrode lead wire 131 and the second electrode lead wire 141 can be reduced or eliminated, which effectively improves the sensitivity and accuracy of the touch. The first flexible circuit board 150 and the second flexible circuit board 151 can also be intersected or overlapped in space to make full use of the three-dimensional space, reduce the width of the frame region, and achieve an ultra-narrow frame.

For example, as shown in FIG. 3a, in the second direction, the first electrode lead wire 131 includes a left first electrode lead wire 131a on the X1 side and a right first electrode lead wire 131b on the X2 side. In the first wiring region 102, the left first electrode lead wire 131a, the right first electrode lead wire 131b, and the second electrode lead wire 141 can be intersected or overlapped in space. In the case where the area of the frame region is less occupied, two lead wires are more advantageous for the first touch electrode 130 to receive the drive signal, and at the same time an ultra-narrow frame is achieved.

For example, the materials of the first touch electrode 130 and the second touch electrode 140 may be transparent conductive materials such as indium tin oxide (ITO), indium zinc oxide (IZO), indium gallium oxide (IGO), gallium zinc oxide (GZO) or carbon nanotubes.

For example, the materials of the first electrode lead wire 131 and the second electrode lead wire 141 may be metal conductive materials, for example, one or more alloys formed by one or more of or any combination of metals selected from the group consisting of molybdenum, copper, aluminum and titanium, or other suitable materials.

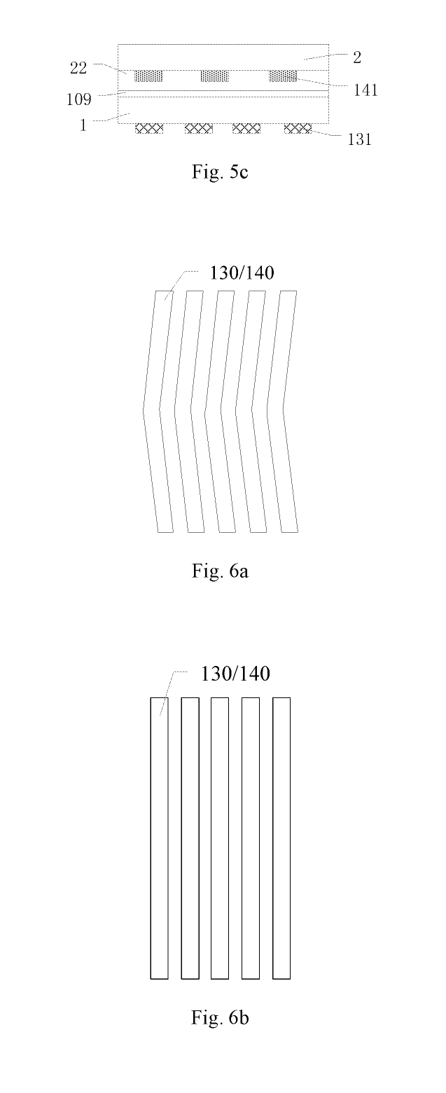

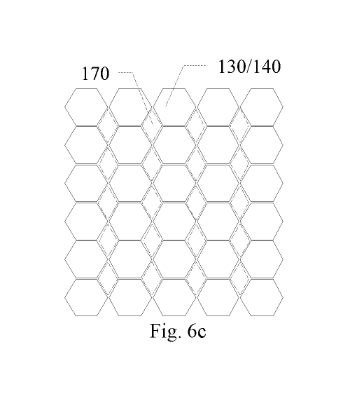

FIGS. 6a-6c are exemplary structural schematic diagrams of different touch electrodes of a touch screen provided by embodiments of the present disclosure.

For example, as shown in FIGS. 2a, 2b, 2c, 3a and 3b, in the present embodiment, the first touch electrode 130 and the second touch electrode 140 may be a rhombic electrode. As shown in FIGS. 6a to 6c, the first touch electrode 130 and/or the second touch electrode 140 may be a parallel jagged electrode, a parallel stripe electrode, or a parallel-arranged polygonal electrode. The embodiments of the present disclosure are not limited to this. As shown in FIG. 6c, when the first touch electrode 130 and/or the second touch electrode 140 are parallel-arranged hexagonal electrodes, an auxiliary sensing electrode 170 may be interposed between the respective touch electrodes 130/140 to compensate for visual differences or to increase the coupling capacity.

### The Second Embodiment

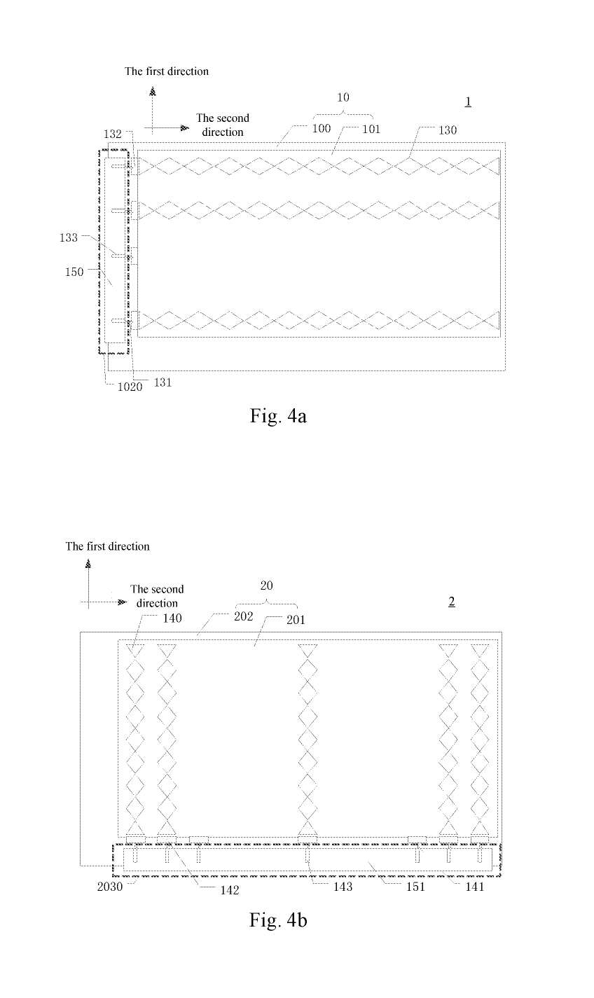

FIG. 4a is a structural schematic diagram of a first surface of a touch screen provided by the second embodiment. FIG. 4b is a structural schematic diagram of a third surface of a touch screen provided by the second embodiment. Only a portion of the relevant structure is shown in FIGS. 4a and 4b for a clearer illustration.

As shown in FIGS. 4a and 4b, the touch screen provided in the second embodiment includes a first substrate 1 and a cover substrate 2 which are overlapped. The first surface 10 is the surface of the first substrate 1 away from the cover substrate 2. The first touch layer is disposed on the first surface 10. The third surface 20 is the surface of the cover substrate 2 facing the first substrate 1. The second touch layer is disposed on the third surface 20. The first touch layer is disposed on the first substrate 1 and the second touch layer is disposed on the cover substrate 2. The first touch layer is insulated from the second touch layer by the first substrate 1. Thus, signal interferences between the first touch layer and the second touch layer can be reduced, which effectively improves the sensitivity and accuracy of the touch.

For example, as shown in FIG. 4b, the third surface 20 includes a third touch region 201 and a third frame region 202. The second touch electrode 140 is provided in the third touch region 201, and the second connection electrode 142 is provided on the edge of the third touch region 201. The third frame region 202 includes a third wiring region 2030 extending in the second direction. And the second electrode pin 143 and the second electrode lead wire 141 are provided in the third wiring region 2030. The second touch electrode 140 is electrically connected to the second electrode lead wire 141 through the second connection electrode 142. The second flexible circuit board 151, for example, may be pressed into the third wiring region 2030 by an anisotropic conductive adhesive and electrically connected to the second electrode lead wire 141 through the second electrode pin 143. The second flexible circuit board 151 is electrically connected to an external driving circuit (or a driving chip, not shown) so that the driving circuit can transmit a control signal to the second touch electrode 140 or receive an induction signal from the second touch electrode 140 to achieve touch detection and touch control.

According to the touch screen provided by the present embodiment, by pressing the first flexible circuit board 150 on the first surface 10 and pressing the second flexible circuit board 151 on the third surface 20, the wirings on the edge can be eliminated, the area of the frame occupied by the electrode lead wires can be significantly reduced to achieve a ultra-narrow frame, and the appearance performance of electronic products can be increased greatly.

It should be noted that, on the first surface 10, two first flexible circuit boards 150 may be provided on both sides of the first touch region 101 in the second direction, which is the same as that of FIG. 2c in the first embodiment, and is more advantageous for the first touch electrode 130 to receive the drive signal.

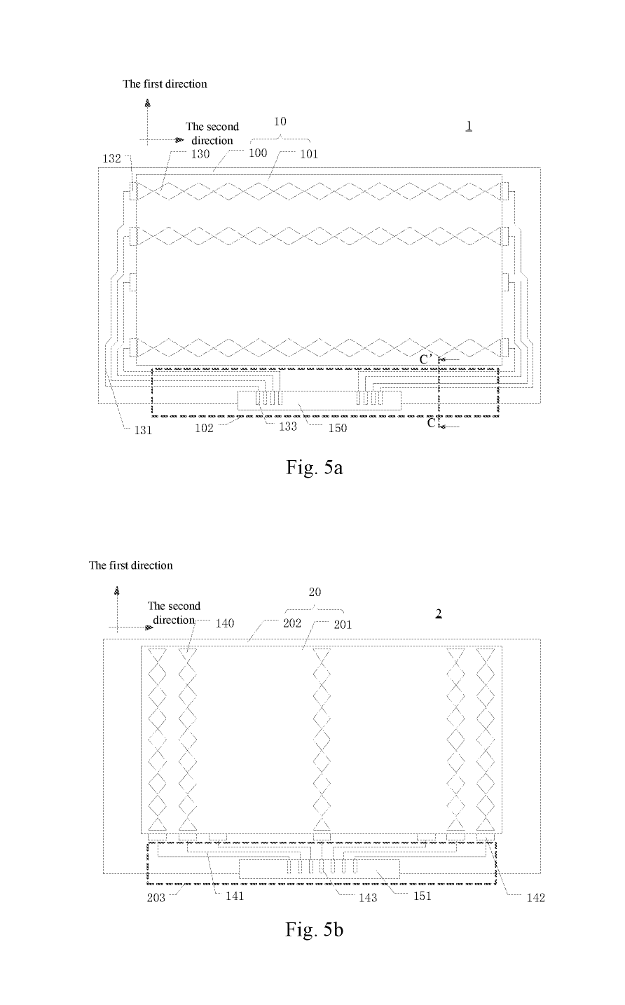

FIG. 5a is a structural schematic diagram of a first surface of another touch screen provided by the second embodiment. FIG. 5b is a structural schematic diagram of a third surface of another touch screen provided by the second embodiment. FIG. 5c is a partial cross-sectional view along the direction of line C-C′ in the FIG. 5a.

As shown in FIGS. 5a to 5c, in another touch screen provided by the second embodiment, a method of wiring on the edge is used to achieve the connection of the touch electrode and the flexible circuit board. The first touch layer is disposed on the first surface 10. The second touch layer is disposed on the third surface 20. The wiring methods of the first touch layer and the second touch layer are the same as those in the first embodiment. The first flexible circuit board 150 and the second flexible circuit board 151 are at least partially overlapped in the direction perpendicular to the plane of the first substrate 1, and the first electrode lead wire 131 and the second electrode lead wire 141 are also at least partially overlapped in the direction perpendicular to the plane of the first substrate 1. By overlapping the upper layer and the lower layer, the number of the electrode lead wires of the first frame region 100 and the third frame region 202 can be reduced, the area of the frame region occupied by the electrode lead wires can be significantly reduced, so as to make full use of the three-dimensional space and achieve an ultra-narrow frame.

For example, as shown in FIG. 5c, the cover substrate 2 is attached to the first substrate 1 by an optical glue 22, and the first substrate 1 may be provided with components such as a polarizing layer 109 according to the needs. The first touch layer is insulated from the second touch layer by the first substrate 1, the polarizing layer 109 and the optical glue 22, so that signal interferences between the first touch electrode 130 and the second touch electrode 140 can be reduced, and parasitic capacitances between the first electrode lead wire 131 and the second electrode lead wire 141 can be reduced or eliminated, which effectively improves the sensitivity and accuracy of the touch. In addition, for this structure, it is also possible to avoid providing an interlayer insulating layer between the first touch electrode 130 and the second touch electrode 140 which are provided separately on different layers, or providing the interlayer insulation pattern between the first touch electrode 130 and the second touch electrode 140 which are provided on the same layer, to achieve bridging between adjacent electrode segments. Thus, the manufacturing process can be simplified, production cost can be reduced, and the product yield can be improved. For example, the polarizing layer may be provided on the outer side of the cover substrate 2 as required.

For example, the cover substrate 2 may be a transparent substrate, and may be, for example, a glass substrate, a ceramic substrate, a plastic substrate, or other suitable substrate.

It should be noted that the structures and the materials of the first touch layer and the second touch layer in this embodiment may be the same as those of the first embodiment, and will not be described again.

### The Third Embodiment

The present embodiment also provides a method for manufacturing a touch screen, and this method can be applied to the touch screen of the above embodiment.

Referring to FIGS. 2a to 5c, the method for manufacturing a touch screen of the present embodiment may include the following steps. A first substrate 1 is provided to form a touch sensing structure. A first flexible circuit board 150 and a second flexible circuit board 151 are provided. The touch sensing structure includes a first touch layer and a second touch layer formed on both sides of the first substrate 1. The first touch layer includes at least one first touch electrode 130 and at least one first electrode lead wire 131. The second touch layer includes at least one second touch electrode 140 and at least one second electrode lead wire 141. The first flexible circuit board 150 and the second flexible circuit board 151 are respectively pressed against both sides of the first substrate 1. The first electrode lead wire 131 is electrically connected to the first flexible circuit board 150, and the second electrode lead wire 141 is electrically connected to the second flexible circuit board 150.

For example, the first substrate 1 has a thickness of 0.2 mm to 0.7 mm. The first touch layer is formed on the first surface 10. The second touch layer is formed on the second surface 11. The first touch layer is insulated from the second touch layer by the first substrate 1, so that signal interferences between the first touch electrode 130 and the second touch electrode 140 can be reduced, and parasitic capacitances between the first electrode lead wire 131 and the second electrode lead wire 141 can be reduced or eliminated, which effectively improves the sensitivity and accuracy of the touch. On the other hand, the first touch layer can be insulated from the second touch layer by the first substrate 1, so that it is not necessary to provide an interlayer insulating layer or make an interlayer insulation pattern to perform bridging between touch electrodes. Thus, the manufacturing process can be simplified and the product yield can be improved.

For example, in one example, the method for manufacturing a touch screen provided by the present embodiment may include the following steps. A cover substrate 2 is provided and attached to the first substrate 1 by an optical glue 22. The first surface 10 is the surface of the first substrate 1 away from the cover substrate 2. The first touch layer is disposed on the first surface 10. The third surface 20 is the surface of the cover substrate 2 facing the first substrate 1. The second touch layer is disposed on the third surface 20. In another example, the first touch layer is insulated from the second touch layer by the first substrate 1, the polarizing layer 109 and the optical glue 22, so that signal interferences between the first touch layer and the second touch layer can be more effectively avoided.

For example, the first direction and the second direction are perpendicular to each other. In the second direction, the first flexible circuit board 150 is pressed on the first surface 10. In the first direction, the second flexible circuit board 151 is pressed on the second surface 11 or the third surface 20. By pressing the first flexible circuit board 150 and the second flexible circuit board 151 on both sides of the first substrate 1, the wirings on the edge can be reduced or eliminated, the area of the frame occupied by the electrode lead wires can be significantly reduced to achieve an ultra-narrow frame, and the appearance performance of electronic products can be increased greatly.

For example, in the second direction, the first flexible circuit board 150 is pressed on the first surface 10. In the second direction, the second flexible circuit board 151 is pressed on the second surface 11 or the third surface 20. The first flexible circuit board 150 and the second flexible circuit board 151 are at least partially intersected or overlapped in the direction perpendicular to the first substrate 1 to make full use of the three-dimensional space and reduce the width of the frame region. By stacking the upper layer and the lower layer, the first electrode lead wire 131 and the second electrode lead wire 131 can be at least partially intersected or overlapped in the direction perpendicular to the plane of the first substrate 1, so that the number of the electrode lead wires of the first frame region 100 and the second frame region 110 can be reduced and the area occupied by the electrode lead wires of the frame region can be significantly reduced to achieve an ultra-narrow frame.

### The Fourth Embodiment

The present embodiment provides a touch display device comprising a touch screen as described in any one of the above embodiments. For example, the touch display device may be any product or component having a display function such as a television, a digital camera, a mobile phone, a watch, a tablet computer, a notebook computer, a navigator, or the like.

It should be noted that in the embodiments of the present disclosure, the first touch electrode 130 is an electrode string arranged in parallel in the second direction, and the second touch electrode 140 is an electrode string arranged in parallel in the first direction, but the first touch electrode 130 and the second touch electrode 140 may be reversed. That is, the first touch electrode 130 may be an electrode string arranged in parallel in the first direction, and the second touch electrode 140 may be an electrode string arranged in parallel in the second direction, the present disclosure is not limited thereto. In addition, although only a few of the first touch electrodes 130 and the second touch electrodes 140 are shown in the drawings of the present disclosure, those skilled in the art will recognize that the number of touch electrodes is not limited to that shown in the drawings.

It should be noted that, for the sake of clarity, the entire structure of the touch screen is not given in the embodiments of the present disclosure. In order to implement the necessary functions of the touch screen, those skilled in the art can provide other structures not shown in view of the particular application. The present disclosure is not intended to limit this.

According to the present disclosure, the following points need to be explained.

(1) The accompanying drawings of the present disclosure relate only to the structure to which the present disclosure relates, and other structures may be referred to the conventional design.

(2) For clarity, the thickness of the layer or region is enlarged or reduced in the drawings for describing the embodiments of the present disclosure, that is, the drawings are not drawn to the actual proportions.

(3) In the event of non-conflict, embodiments of the present disclosure and the features of the embodiments may be combined with each other to obtain a new embodiment.

The above described are only the specific embodiments of the present disclosure, but the protection scope of the present disclosure is not limited thereto, and the protection scope of the present disclosure should be based on the protection scope of the claims.

What is claimed is:

1. A touch screen, comprising:
a first substrate;
a touch sensing structure comprising a first touch layer and a second touch layer;
a first flexible circuit board and a second flexible circuit board,
wherein the first touch layer and the second touch layer are respectively provided on both sides of the first substrate, the first touch layer comprises at least one first electrode lead wire, and the second touch layer comprises at least one second electrode lead wire, the first flexible circuit board and the second flexible circuit board are respectively pressed on both sides of the first substrate, the first electrode lead wire is electrically connected with the first flexible circuit board, and the second electrode lead wire is electrically connected with the second flexible circuit board.

2. The touch screen of claim 1, wherein both sides of the first substrate are respectively a first surface and a second surface, the first touch layer is disposed on the first surface, and the second touch layer is disposed on the second surface.

3. The touch screen of claim 2, wherein a first wiring region is disposed on the first surface, a second wiring region is disposed on the second surface, the first wiring region extends in a first direction on the first surface, the second wiring region extends in a second direction on the second surface, the first flexible circuit board is pressed on the first wiring region, the second flexible circuit board is pressed on the second wiring region, and the first direction is perpendicular to the second direction.

4. The touch screen of claim 2, wherein a first wiring region is disposed on the first surface, a second wiring region is disposed on the second surface, the first wiring region extends in a first direction on the second surface, the second wiring region extends in a second direction on the second surface, the first flexible circuit board is pressed on the first wiring region, the second flexible circuit board is pressed on the second wiring region, and the first wiring region and the second wiring region are at least partially overlapped in a direction perpendicular to the first substrate.

5. The touch screen of claim 1, further comprising a cover substrate, wherein the cover substrate is attached to the first substrate by an optical glue, a surface of the cover substrate facing the first substrate is a third surface, the second touch layer is disposed on the third surface, a surface of the first substrate away from the cover substrate is a first surface, and the first touch layer is disposed on the first surface.

6. The touch screen of claim 5, wherein the first substrate comprises a first wiring region, the cover substrate comprises a third wiring region, the first wiring region extends in a first direction on the first surface, the third wiring region extends in a second direction on the third surface, the first flexible circuit board is pressed on the first wiring region, the second flexible circuit board is pressed on the third wiring region, and the first direction is perpendicular to the second direction.

7. The touch screen of claim 5, wherein the first substrate comprises a first wiring region, the cover substrate comprises a third wiring region, the first wiring region extends in a second direction on the first surface, the third wiring region extends in a second direction on the third surface, the first flexible circuit board is pressed on the first wiring region, the second flexible circuit board is pressed on the third wiring region, and the first wiring region and the third wiring region are at least partially overlapped in a direction perpendicular to the first substrate.

8. A method for manufacturing a touch screen, comprising:
providing a first substrate;
forming a touch sensing structure;
providing a first flexible circuit board and a second flexible circuit board,
wherein the touch sensing structure comprises a first touch layer and a second touch layer, the first touch layer and the second touch layer are respectively provided on both sides of the first substrate, the first touch layer comprises at least one first electrode lead wire, and the second touch layer comprises at least one second electrode lead wire, the first flexible circuit board and the second flexible circuit board are respectively pressed on both sides of the first substrate, the first electrode lead wire is electrically connected with the first flexible circuit board, and the second electrode lead wire is electrically connected with the second flexible circuit board.

9. The method for manufacturing a touch screen of claim 8, wherein both sides of the first substrate are respectively a first surface and a second surface, the first touch layer is disposed on the first surface, and the second touch layer is disposed on the second surface.

10. The method for manufacturing a touch screen of claim 9, further comprising: forming a first wiring region on the first surface, forming a second wiring region on the second surface, wherein the first wiring region extends in a first direction on the first surface, the second wiring region extends in a second direction on the second surface, the first flexible circuit board is pressed on the first wiring region, the second flexible circuit board is pressed on the second wiring region, and the first direction is perpendicular to the second direction.

11. The method for manufacturing a touch screen of claim 9, further comprising: forming a first wiring region on the first surface, forming a second wiring region on the second surface, wherein the first wiring region extends in a second direction on the first surface, the second wiring region extends in a second direction on the second surface, the first flexible circuit board is pressed on the first wiring region, the second flexible circuit board is pressed on the second wiring region, and the first wiring region and the second wiring region are at least partially overlapped in a direction perpendicular to the first substrate.

12. The method for manufacturing a touch screen of claim 8, further comprising: providing a cover substrate, wherein the cover substrate is attached to the first substrate by an optical glue, a surface of the first substrate away from the cover substrate is a first surface, and the first touch layer is disposed on the first surface, and a surface of the cover substrate facing the first substrate is a third surface, the second touch layer is disposed on the third surface.

13. The method for manufacturing a touch screen of claim 8, further comprising: forming a first wiring region on the first substrate, forming a third wiring region on the cover substrate, wherein the first wiring region extends in a first direction on the first surface, the third wiring region extends in a second direction on the third surface, the first flexible circuit board is pressed on the first wiring region, the second flexible circuit board is pressed on the third wiring region, and the first direction is perpendicular to the second direction.

14. The method for manufacturing a touch screen of claim 8, further comprising: forming a first wiring region on the first substrate, forming a third wiring region on the cover substrate, wherein the first wiring region extends in a second direction on the first surface, the third wiring region extends in a second direction on the third surface, the first flexible circuit board is pressed on the first wiring region, the second flexible circuit board is pressed on the third wiring region, and the first wiring region and the third wiring region are at least partially overlapped in a direction perpendicular to the first substrate.

15. A touch display device comprising the touch screen of claim 1.

16. A touch display device comprising the touch screen of claim 2.

17. A touch display device comprising the touch screen of claim 3.

18. A touch display device comprising the touch screen of claim 4.

19. A touch display device comprising the touch screen of claim 5.

20. A touch display device comprising the touch screen of claim 6.
